(19) United States
(12) Patent Application Publication
(10) Pub. No.: US 2011/0031754 A1
(43) Pub. Date: Feb. 10, 2011

(54) APPARATUS FOR GENERATING POWER FROM A FLUID STREAM

(76) Inventor: Marc Paish, Hull (GB)

Correspondence Address: HOWARD & HOWARD ATTORNEYS PLLC, 450 West Fourth Street, Royal Oak, MI, 48067, US

(21) Appl. No.: 12/745,077

(22) PCT Filed: Nov. 19, 2008
(86) PCT No.: PCT/GB2008/003869

§ 371 Date: Oct. 29, 2010

(30) Foreign Application Priority Data
Nov. 27, 2007 (GB) 0723286.1

(51) Int. Cl. F03B 17/06

(52) U.S. Cl. 290/54

(57) ABSTRACT

An apparatus for generating power from a fluid stream comprising a foil arm connected to a support by a pivot; a bidirectional foil comprising first and second edges connected to the foil arm remote from the pivot; and, an actuator connected between bidirectional foil and foil arm, the actuator being adapted to adjust the angle between foil and foil arm.

The present invention relates to an apparatus for generating power from a fluid stream. More particularly, but not exclusively, the present invention relates to an apparatus for generating power from a fluid stream comprising a foil arm pivotally connected to a frame, a bidirectional foil connected to the foil arm remote from the pivot and a linear actuator for adjusting the angle between foil arm and bidirectional foil.

U.S. Pat. No. 5,899,664 discloses an apparatus for generating power from a fluid stream. The apparatus comprises a foil arm connected by a pivot at one end to a frame and a foil at the other. Oscillation of the arm from side to side drives a generator so producing electricity. At the end of each oscillation the foil arm is rotated along its length, reversing the direction of the foil so enabling the foil arm to travel in the opposite direction.

Reversal of the foil by rotation of the foil arm along its length is a relatively inefficient process, requiring a large degree of energy. In addition, this approach does not scale well and is only suitable for use with relatively small foils which can be supported by a single foil arm. Larger foils need to be supported at a plurality of points along their length in order to maintain the required high degree of rigidity. This can be problematic if the foil is required to be rotated as described above. One of the foil arms can be rotated about its length. The remainder of the foil arms however need to be rotated about an arc centred on the axis of rotation. This requires a complex linkage mechanism which is expensive to manufacture and maintain.

Accordingly, the present invention provides an apparatus for generating power from a fluid stream comprising

a foil arm connected to a support by a pivot;

a bidirectional foil comprising first and second edges connected to the foil arm remote from the pivot; and,

an actuator connected between bidirectional foil and foil arm, the actuator being adapted to adjust the angle between foil and foil arm.

Such an apparatus can change the direction of oscillation of the foil arm in the stream by only a small movement of the foil relative to the foil arm. This is very efficient. The apparatus also scales well. Large foils can be employed and the desired degree of rigidity maintained by connecting the foil to a plurality of arms, each having an actuator. As the foil size is increased one can simply increase the number of foil arms without any significant increase in the complexity of the device.

Preferably, the first and second edges of the foil define a chord plane.

The foil can be symmetric about the chord plane. Preferably, the two faces of the foil on opposite sides of the chord plane are convex.

Alternatively, the foil is asymmetric about the chord plane.

The two faces on opposite sides of the cord plane can be convex, the curvature of one face being greater than the other.

Alternatively, one side of the foil can be concave and the other can be convex.

Preferably, the foil is cambered with the low pressure convex side having a greater degree of curvature than the high pressure concave side.

Alternatively, the thickness of the foil is constant between first and second edges.

As a further alternative, one side of the foil is convex and the other is flat.

Preferably, the foil is symmetric about a plane normal to and bisecting the cord plane.

Preferably, the apparatus comprises a plurality of foil arms, each foil arm having a bidirectional foil connected thereto.

Preferably, at least two of the foil arms are connected to the same bidirectional foil.

Preferably, the apparatus comprises a plurality of bidirectional foils, at least one foil being connected to a single foil arm.

Preferably, the apparatus further comprises an actuator between each foil arm and its associated foil.

Preferably, the oscillations of at least two of the foil arms are out of phase.

The present invention will now be described by way of example only, and not in any limitative sense with reference to the accompanying drawings in which

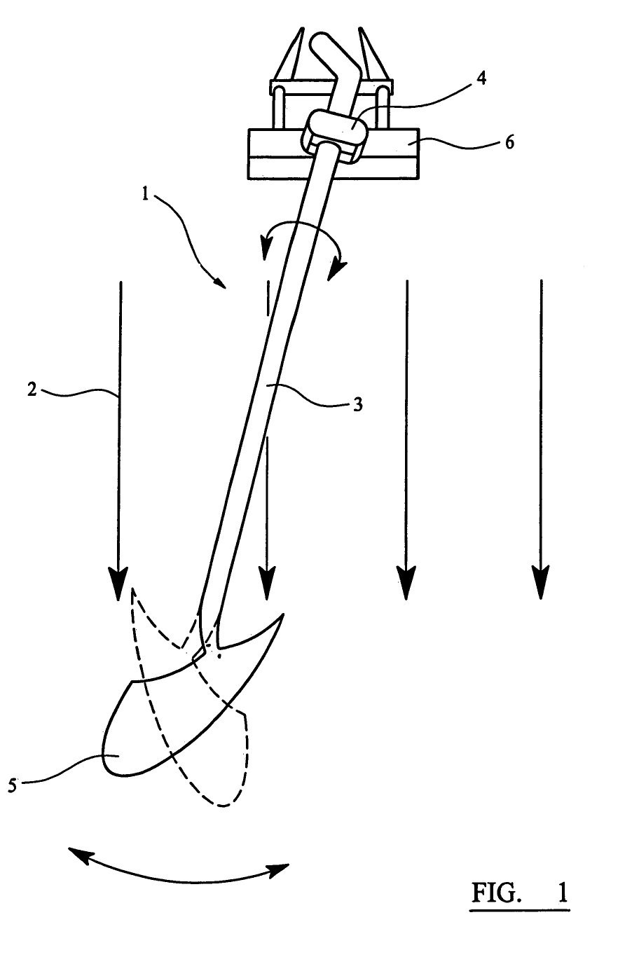

FIG. 1 shows a known apparatus for generating power from a fluid stream in schematic form;

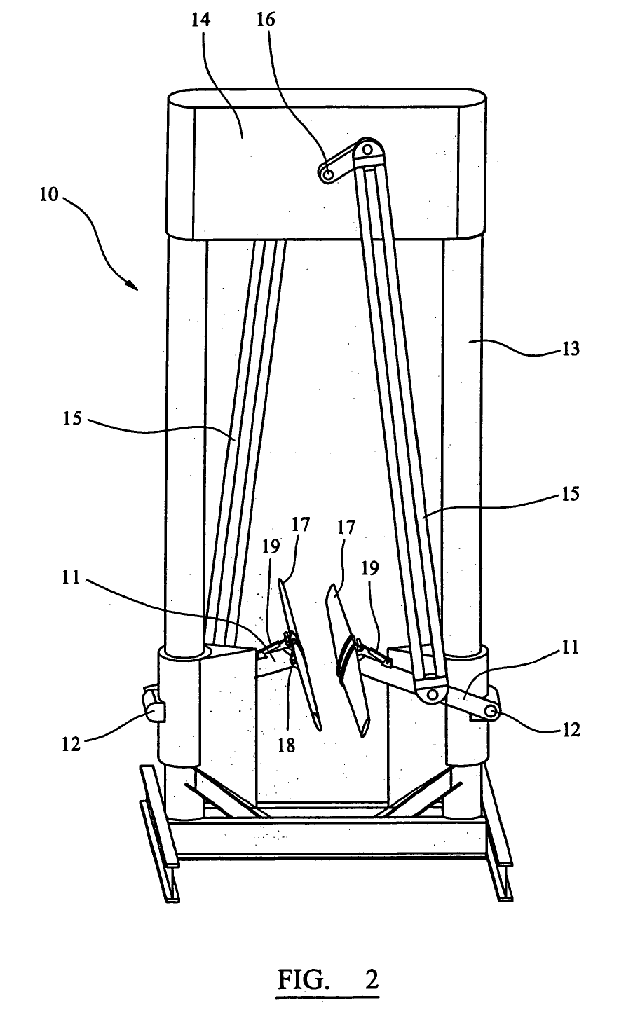

FIG. 2 shows an apparatus according to the invention in perspective view;

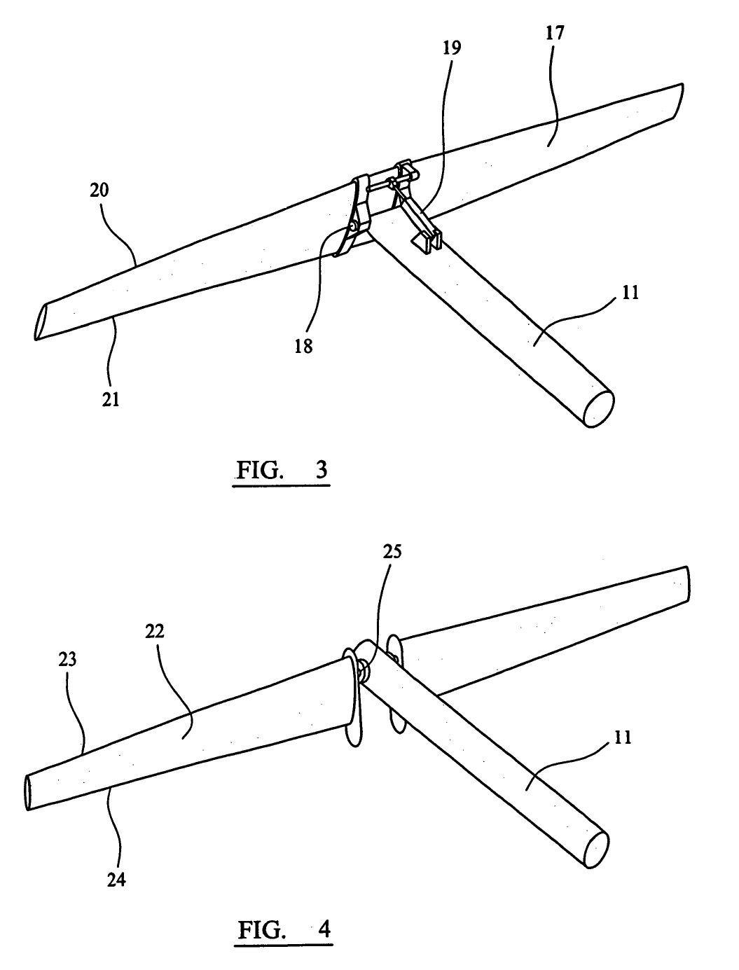

FIG. 3 shows the foil arm, foil and actuator of FIG. 2 in detail;

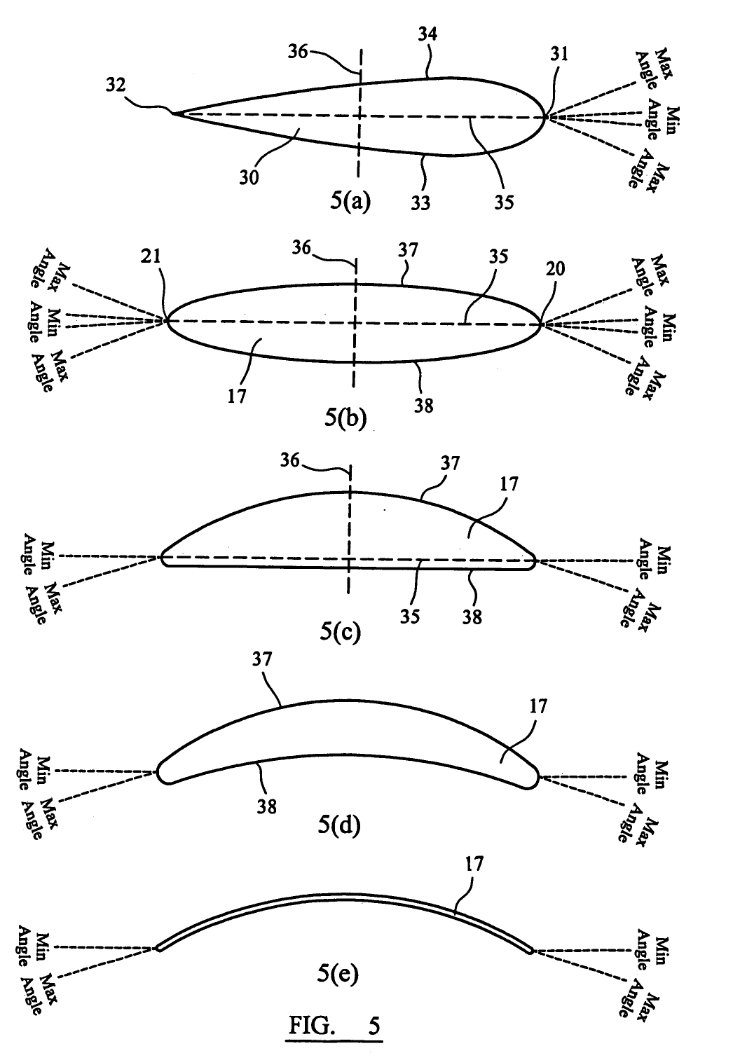

FIG. 4 shows a foil, foil arm and actuator of an apparatus not according to the invention in perspective view; and,

FIG. 5 shows a plurality of foils including teardrop and bi-directional foils.

Shown in FIG. 1 is a known apparatus 1 for generating power from a fluid stream 2. The apparatus 1 comprises a foil arm 3 connected to a pivot 4. A foil 5 is connected to the foil arm 3 remote from the pivot 4.

The pivot 4 is attached to a frame 6. Connected to the frame 6 is a generator (not shown). A linkage (not shown) connects the foil arm 3 to the generator and converts the pivoting motion of the foil arm 3 into rotation of a crank (not shown). The crank rotates a portion of the generator, so generating electrical power.

In use the apparatus 1 is arranged with the foil 5 in a flowing fluid stream 2. The foil 5 is shaped such that flow of the fluid 2 over the foil 5 displaces the foil 5 sideways, pivoting the foil arm 3 about the pivot 4. When the foil arm 3 reaches the edge of one oscillation the foil arm 3 is rotated about its length so that the direction of the foil 5 is now reversed. The flow of the fluid 2 now urges the foil arm 3 in the opposite direction. The process is repeated when the foil arm 3 reaches the opposite end of the range of motion, so resulting in a foil arm 3 which oscillates from side to side.

Rotation of the foil arm 3 at the end of each oscillation is relatively inefficient. Energy extracted from the stream 2 which could be used to pivot the foil arm 3 must instead be used to rotate the foil 5. In addition, the apparatus only works well when the foil 5 is small. As the foil 5 is only connected to the foil arm 3 at a single point the stresses at this point rapidly increase as the foil length is increased. This limits maximum foil length and hence generating capacity. Connection of the foil 5 to a plurality of foil arms 3 to increase rigidity results in a mechanism which is complex as all the foil arms 3 must be able to rotate about a common axis whilst still being able to drive the crank arm.

Shown in FIG. 2 is an apparatus 10 for generating power from a fluid stream according to the invention. In contrast to the apparatus of FIG. 1 the foil arms 11 oscillate in a vertical, rather than a horizontal plane. In alternative embodiments of the invention the apparatus comprises foil arms 11 which oscillate from side to side in the horizontal plane.

The apparatus 10 comprises foil arms 11 each of which is connected at a pivot 12 to a frame 13. Also connected to the frame 13 is a generator 14 connected to the foil arms 11 by linkages 15. Up and down oscillation of the foil arms 11 rotates the crank arm 16 of the generator 14, so generating electrical power.

Connected to each of the foil arms 11 remote from the pivots 12 is a bi-directional foil 17. Each foil 17 is connected to its associated foil arm 11 by a foil pivot 18. An actuator 19 extends between each foil arm 11 and associated foil 17 as shown. Each actuator 19 is adapted to adjust the angle between the associated foil arm 11 and foil 17 by lengthening or shortening when in use.

The end of each foil arm 11 is shown in further detail in FIG. 3. The foil 17 is a bidirectional foil having first and second edges 20, 21. The bi-directional foil 17 is capable of generating significant useable force (lift) when fluid flows from the first edge 20 to the second 21 edge or vice versa.

In use the foil arm 11 displaces the foil 17 with a speed which is typically much more rapid than the speed of the fluid flow. As is shown in FIG. 2, the foils 17 of this embodiment are arranged in substantially a vertical plane. Because of the speed difference between the fluid and the foil 17, from the frame of reference of the foil 17 the fluid appears to flow from the first edge 20 of the foil 17 to the rear edge 21. The foil 17 is inclined slightly to the vertical by the actuator 19 so that the fluid flows asymmetrically over the foil 17 and the foil 17 generates lift. When the foil arm 11 reaches an edge of its range of motion the actuator 19 displaces the foil 17 slightly to the other side of vertical. The fluid now flows over the foil 17 in the opposite direction and the foil 17 now generates lift in the opposite direction. When the foil arm 11 reaches the other extreme of its range of motion the actuator 19 again displaces the foil 17 to the other side of the vertical and the oscillation begins again.

Because of the bi-directional nature of the foil 17, only very small displacements of the foil 17 are required at the edges of each oscillation, displacing the foil 17 from one side of the vertical to the other. This small displacement is sufficient to reverse the direction of flow over the foil 17 so reversing the direction of lift. This is highly efficient and requires little energy from the linear actuator 19.

Shown in FIG. 4 is the end of the foil arm 11 of an embodiment similar to that of FIG. 3 but not according to the invention. In this embodiment the foil 22 is a known unidirectional teardrop foil. The foil 22 generates useable lift when the fluid flows from a first edge 23 to a second edge 24. In the reverse direction the foil 22 produces negligible lift (if any). In use the foil 22 must be rotated through 180 degrees at the end of each oscillation of the foil arm 11. Compared to the embodiment of the invention this is relatively inefficient. In addition, due to the requirement to rotate the foil 22 through 180 degrees the actuator 25 is a rotary actuator. Rotary actuators tend to be expensive, difficult to maintain and have lower torque capacity than the arrangement shown in FIG. 3.

In the embodiments shown in FIGS. 2 and 3, the linear actuator 19 adjust the angle of the foil 17 relative to the foil arm 11 when the foil arm 11 is proximate to an extremity of its oscillation. The foil 17 remains fixed relative to the foil arm 11 for the remainder of the oscillation. In an alternative embodiment the linear actuator 19 continuously adjusts the angle between foil 17 and foil arm 11 throughout the oscillation of the foil arm 11. This ensures that the angle of attack of the foil 17 in the stream is always at its optimum value. This further increases efficiency.

The embodiment shown in FIG. 2 comprises a plurality of foil arms 11 each connected to a single foil 17. In this embodiment the foils 17 oscillate approximately 90 degrees out of phase with each other as shown such that their combined output provides a steady torque to the shaft driven by crank arms 16. In alternative embodiments different phase relations between foils 17 are possible, preferably with the foils out of phase with each other.

In an alternative embodiment (not shown), each foil 17 is connected to a plurality of arms 11 and associated actuators 19. This allows the use of larger foils 17 without any significant increase in complexity.

Shown in FIG. 5 are a plurality of foil cross sections. Shown in FIG. 5(a) is a known teardrop foil 30 for use in an apparatus which is not according to the invention. The teardrop foil 30 comprises a leading edge 31 and a trailing edge 32 and first and second surfaces 33, 34 extending therebetween. Both the first and second surfaces 33, 34 are convex.

One can define a chord surface 35 extending from the front edge 31 to the rear edge 32 and a normal surface 36 which bisects the chord surface 35 and is normal to it. The teardrop foil 30 is asymmetric about the normal surface 36.

If a teardrop foil 30 faces directly into the direction of fluid flow it does not generate any lift because the fluid flows symmetrically over both the first and second faces 33, 34. If the foil 30 is inclined slightly to the fluid flow such that the attack angle lies between minimum and maximum attack angles shown the fluid flows smoothly but asymmetrically, flowing more rapidly over one face 33, 34 than the other. The surfaces 33, 34 are shaped such that this results in a high pressure side and a low pressure side, producing lift.

It is possible to employ members other than foils in apparatus for obtaining power from a fluid stream. For example, one can employ a simple planar member (not shown) inclined to the direction of fluid flow. As the fluid is incident on the planar member its change of direction imparts a force on the member which can be used to displace an arm and hence generate power. In this case however the planar member is not acting as a foil with substantially smooth flow over both surfaces producing lift. As the fluid flows around the planar member it generates a complex turbulent pattern on the downstream side of the member which is highly inefficient.

Returning to the teardrop foil 30, the foil 30 is unidirectional and is only shaped to act as a foil when the leading edge 31 faces substantially into the direction of flow. If the trailing edge 32 faces into the direction of flow one does not obtain foil behaviour. Accordingly, a device employing such a foil 30 must rotate the foil 30 through 180 degrees at the end of each stroke as previously described with reference to FIG. 4.

Shown in FIG. 5(b) is a bidirectional foil 17 suitable for use in an apparatus according to the invention. The foil 17 comprises first and second edges 20, 21 and first and second convex faces 37, 38 extending therebetween. In contrast to the teardrop foil 30, the bidirectional foil 17 is symmetric about the normal surface 36 which bisects the chord surface 35.

Because the foil 17 is a bidirectional foil it can generate lift when either of the first or second edges 20, 21 are directed substantially into the fluid stream, provided the angle of attack of the foil 17 is within the minimum and maximum attack angles (the acceptance range). To use the foil in an apparatus according to the invention one simply needs to flip the foil 17 from one side of the vertical to the other and the edge of each oscillation of the foil arm 11. The fluid then flows over the foil 17 in the opposite direction reversing the direction of lift so enabling the oscillation to continue.

The foil 17 shown in FIG. 5(b) is symmetric about the chord surface 35. Such a foil 17 is particularly suitable for use in tidal streams as the foil 17 will function equally well even if the direction of fluid flow is reversed.

In an alternative embodiment of the invention (not shown) the apparatus employs bidirectional foils 17 wherein both faces are convex although one face is more convex than the other.

Shown in FIG. 5(c) is a further bi-directional foil 17 for use with an apparatus according to the invention. Again, the foil 17 is symmetric about the normal plane 36 which bisects the chord plane 35. In this embodiment one of the two faces 37, 38 is planar whilst the other is curved as shown. Such foils which are not symmetrical about the chord plane are referred to as cambered. These foils are able to generate more lift without increasing drag than un-cambered foils, but have a more restricted acceptance range. The more limited acceptance range means that the foil 17 is preferably used in a system wherein the foil 17 is continuously oriented relative to the fluid flow.

FIG. 5(d) shows another embodiment of a bidirectional foil 17 according to the invention. The foil 17 is similar to that of FIG. 5(c) except the underside 38 is concave. The curvature of one side is slightly different to that of the other as shown with the low pressure convex side 37 having greater curvature than the high pressure concave side 38 such that the thickness of the foil 17 varies along its length.

The embodiment of FIG. 5(e) is similar to that of FIG. 5(d) but is not cambered. The foil 17 has a uniform thickness along its length. Such a foil 17 is similar to the sail on a yacht. The foil 17 has a smaller acceptance range and lower efficiency than the foil 17 of FIG. 5(d) but is simpler to manufacture.

A number of different curved surfaces are possible for the faces 37, 38 of the foils 17. In a preferred embodiment the surfaces 37, 38 are elliptical.

All of the bi-directional foils 17 described above are symmetric about the normal plane 36. Bi-directional foils 17 which are asymmetric about this normal plane 36 are also suitable for use with the apparatus according to the invention.

1. An apparatus for generating power from a fluid stream comprising
a foil arm connected to a support by a pivot;
a bidirectional foil comprising first and second edges connected to the foil arm remote from the pivot; and,
an actuator connected between the bidirectional foil and the foil arm, the actuator being adapted to adjust an angle between the bidirectional foil and the foil arm.

2. An apparatus as claimed in claim 1, wherein the first and second edges of the bidirectional foil define a chord plane.

3. An apparatus as claimed in claim 2, wherein the bidirectional foil is symmetric about the chord plane.

4. An apparatus as claimed in claim 3, wherein two faces of the bidirectional foil on opposite sides of the chord plane are convex.

5. An apparatus as claimed in claim 2, wherein the bidirectional foil is asymmetric about the chord plane.

6. An apparatus as claimed in claim 5, wherein two faces on opposite sides of the cord plane are convex, the curvature of one face being greater than the other.

7. An apparatus as claimed in claim 5, wherein one side of the bidirectional foil is concave and the other is convex.

8. An apparatus as claimed in claim 7, wherein the bidirectional foil is cambered with a low pressure convex side having a greater degree of curvature than a high pressure concave side.

9. An apparatus as claimed in claim 7, wherein a thickness of the bidirectional foil is constant between the first and second edges.

10. An apparatus as claimed in claim 5, wherein one side of the bidirectional foil is convex and the other is flat.

11. An apparatus as claimed in claim 2, wherein the bidirectional foil is symmetric about a plane normal to and bisecting the cord plane.

12. An apparatus as claimed in claim 1, comprising a plurality of foil arms, each foil arm having a bidirectional foil connected thereto.

13. An apparatus as claimed in claim 12, wherein at least two of the foil arms are connected to the same bidirectional foil.

14. An apparatus as claimed in claim 12, comprising a plurality of bidirectional foils, at least one foil being connected to a single foil arm.

15. An apparatus as claimed in claim 12, further comprising an actuator between each foil arm and its associated foil.

16. An apparatus as claimed in claim 12, wherein the oscillations of at least two of the foil arms are out of phase.

17.-18. (canceled)
